(19) United States
(12) Patent Application Publication
(10) Pub. No.: US 2022/0323996 A1
(43) Pub. Date: Oct. 13, 2022

(54) Trommel With Gated Flow Diverters

(71) Applicant: Polydeck Screen Corporation, Spartanburg, SC (US)

(72) Inventors: Bryan D. Player, Boiling Springs, NC (US); Ray Clubb, WELLFORD, SC (US)

(21) Appl. No.: 17/715,277

(22) Filed: Apr. 7, 2022

Related U.S. Application Data
(60) Provisional application No. 63/172,237, filed on Apr. 8, 2021.

(51) Int. Cl. B07B 1/22; B07B 1/18

(52) U.S. Cl. CPC B07B 1/22; B07B 1/185

(57) ABSTRACT

A trommel assembly includes a trommel frame, a plurality of screen panels mounted to the trommel frame to define a material processing channel configured for receipt of screening material, and a gate assembly mounted to the plurality of screen panels. The gate assembly extends into the material processing channel along a radial direction and includes a plurality of circumferential dams that extend substantially along a circumferential direction and are spaced apart along an axial direction to define a plurality of screening stages. The gate assembly further includes a plurality of transfer gates extending at a transfer angle relative to the circumferential direction between adjacent dams of the plurality of circumferential dams, wherein the plurality of transfer gates connect the plurality of screening stages such that rotating the trommel assembly advances the screening material through the material processing channel.

### PRIORITY CLAIM

The present application claims priority to U.S. Provisional Application Ser. No. 63/172,237, titled “Trommel With Gated Flow Diverters,” filed on Apr. 8, 2021, which is incorporated herein by reference.

### FIELD

The present disclosure relates generally to screening systems, and more particularly, to screening systems having trommels.

### BACKGROUND

Trommels are cylindrical shaped sorting devices used to separate one material from another. For instance, trommel screens are used in the mining industry, mineral processing industry, or both to separate a target sized material from a slurry or dry material stream. In particular, target sized and smaller material can pass through a screening media of a trommel, whereas larger particles do not pass through the screening media. Instead, the larger particles are directed along the trommel towards a waste or reprocessing circuit.

### SUMMARY

Aspects and advantages of embodiments of the present disclosure will be set forth in part in the following description, or may be learned from the description, or may be learned through practice of the embodiments.

In one example embodiment, a trommel assembly defining an axial direction, a radial direction, and a circumferential direction is provided. The trommel assembly includes a trommel frame, a plurality of screen panels mounted to the trommel frame to define a material processing channel inside the plurality of screen panels along the radial direction, the material processing channel being configured for receipt of screening material, and a gate assembly mounted to the plurality of screen panels, the gate assembly extending into the material processing channel along the radial direction. The gate assembly includes a plurality of circumferential dams that extend substantially along the circumferential direction, the plurality of circumferential dams being spaced apart along the axial direction to define a plurality of screening stages and a plurality of transfer gates, each of the plurality of transfer gates extending at a transfer angle relative to the circumferential direction between adjacent dams of the plurality of circumferential dams, wherein the plurality of transfer gates connect the plurality of screening stages such that rotating the trommel assembly advances the screening material through the material processing channel.

In another example embodiment, a gate assembly mounted within a trommel is provided. The trommel defines an axial direction, a radial direction, and a circumferential direction, and includes a trommel frame supporting a plurality of screen panels to define a material processing channel. The gate assembly includes a plurality of circumferential dams mounted to the plurality of screen panels and extending substantially along the circumferential direction, the plurality of circumferential dams being spaced apart along the axial direction to define a plurality of screening stages and a plurality of transfer gates, each of the plurality of transfer gates extending at a transfer angle relative to the circumferential direction between adjacent dams of the plurality of circumferential dams, wherein the plurality of transfer gates connect the plurality of screening stages.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures.

FIG. 1 depicts a perspective view of a trommel assembly according to example embodiments of the present disclosure.

FIG. 2 depicts the example trommel assembly of FIG. 1 with screening panels removed for clarity and to reveal a trommel frame according to example embodiments of the present disclosure.

FIG. 3 depicts a close-up view of the example trommel frame of FIG. 2 according to example embodiments of the present disclosure.

FIG. 4 depicts a perspective view of an example screen panel that may used with the example trommel assembly of FIG. 1 according to example embodiments of the present disclosure.

FIG. 5 depicts a close-up, cross-sectional view of screen panels attached to the example trommel frame of FIG. 2 according to example embodiments of the present disclosure.

FIG. 6 depicts a cross-sectional view of the example trommel assembly of FIG. 1 taken along Line 6-6 of FIG. 1 and illustrating a gate assembly according to example embodiments of the present disclosure.

FIG. 7 depicts a perspective view of the example gate assembly of FIG. 6 according to example embodiments of the present disclosure.

FIG. 8 depicts another perspective view of the example gate assembly of FIG. 6 according to example embodiments of the present disclosure.

FIG. 9 depicts a schematic representation an unfolded trommel assembly, illustrating a flow path created by the example gate assembly of FIG. 6 according to example embodiments of the present disclosure.

Repeat use of reference characters in the present specification and drawings is intended to represent the same or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure body such modifications and variations.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “example” is used herein to mean “serving as an example, instance, or illustration.” In addition, references to “an embodiment” or “one embodiment” does not necessarily refer to the same embodiment, although it may. Any implementation described herein as “example” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to trommels for screening systems. For instance, a trommel according to example aspects of the present disclosure can include a screening media and a plurality of flow control devices positioned on the screening media. Each of the flow control devices can be spaced from one another along a length of the screening media to define a plurality of circumferential channels. Each of the flow control devices can include a flow diverter (e.g., scroll, dam, gate) positioned to allow material flowing along a first circumferential channel of the plurality of circumferential channels to flow to a second circumferential channel of the plurality of circumferential channels that is adjacent the first circumferential channel. As such, the flow diverter associated with each of the flow control devices can be operated such that material successively flows through the plurality of circumferential channels to maximize contact between apertures defined by the screening media. In this manner, target sized material can have multiple opportunities (e.g., each circumferential channel) to pass through the screening media and therefore be separated from larger material that is intended to be discharged.

In some implementations, the trommel can rotate nine times before material on the screening media is discharged. In alternative implementations the trommel can rotate more or fewer times before the material on the screening media is discharged. It should be understood that the size of the flow control devices and a width of each of the circumferential channels can vary as needed to accommodate characteristics of the material being sorted. It should also be understood that the flow diverter can be positioned on the screening media such that the flow diverter does not obscure apertures defined by the screening media.

Trommels according to example aspects of the present disclosure can provide numerous technical effects and benefits. For instance, contact between target material and the screening media is increased due, in part, to the plurality of flow control devices being circumferentially spaced apart from one another along the screening media to define a plurality of circumferential channels. Furthermore, wear patterns on the screening media are more uniform. Still further, trommels according to example embodiments of the present disclosure can be smaller comparted to conventional trommels since material must flow around the screening media multiple times before being discharged. In this manner, trommels according example embodiments of the present disclosure can weigh less than conventional trommels.

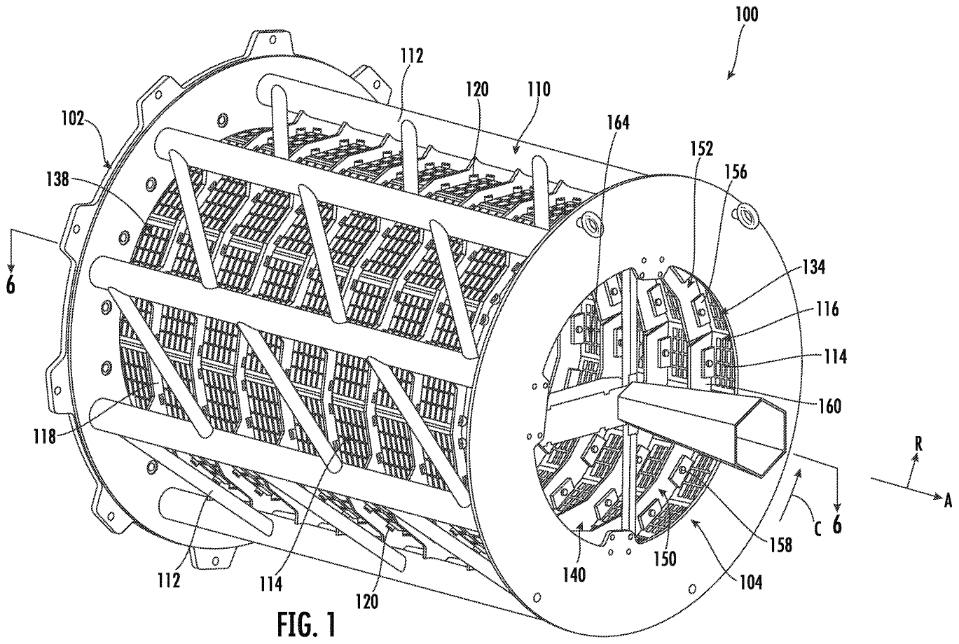

Referring now to the figures, FIG. 1 illustrates a trommel assembly 100 according to example embodiments of the present subject matter. In general, trommel assembly 100 defines an axial direction A, a radial direction R that extends perpendicular to the axial direction A, and a circumferential direction C that extends around the axial direction A. Trommel assembly 100 may generally extend along the axial direction A between a feed end 102 and a discharge end 104. In addition, trommel assembly 100 may be mounted to a drive assembly (not shown). During operation, a mixture of aggregate material, referred to herein generally as screening material, is supplied into feed end 102 while trommel assembly 100 is rotated to advance the screening material toward discharge end 104. The screening material may be supplied into trommel assembly 100 from any suitable source, e.g., such as a milling apparatus, grinding apparatus, etc. The drive assembly may be mechanically coupled to trommel assembly 100 and may be configured to selectively rotate trommel assembly 100 about the axial direction A, thereby urging the screening material through the trommel assembly 100 to the discharge end 104 to facilitate a material screening process, as would be understood to one having ordinary skill in the art.

Trommel assembly 100 may generally include a trommel frame 110 that serves as the primary support structure for trommel assembly 100. For example, trommel frame 110 may include any suitable number, size, and configuration of support structures 112, beams, etc. to provide a frame suitable for withstanding the forces associated with screening large amounts of heavy materials. In addition, the drive assembly may be directly coupled to trommel frame 110 for rotating trommel assembly 100. As shown, trommel frame 110 generally defines a central passage with a cylindrical profile through which screening material will pass, as described in more detail below. In addition, it should be appreciated that trommel frame 110 may be rotationally supported on both ends by one or more support structures or bearings (not shown).

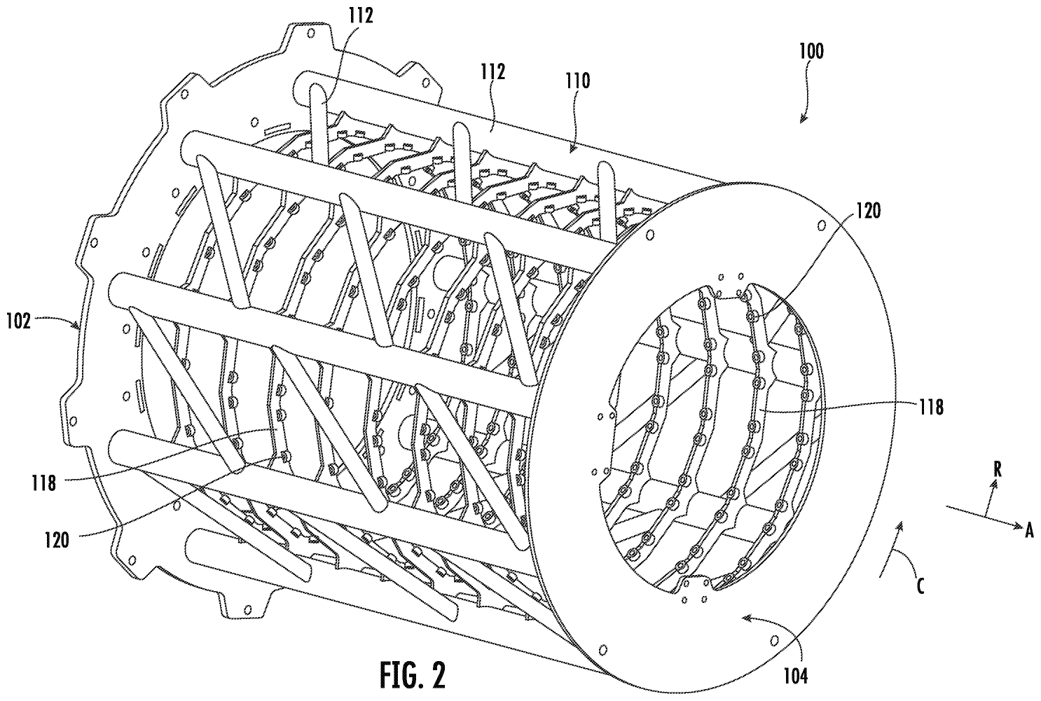

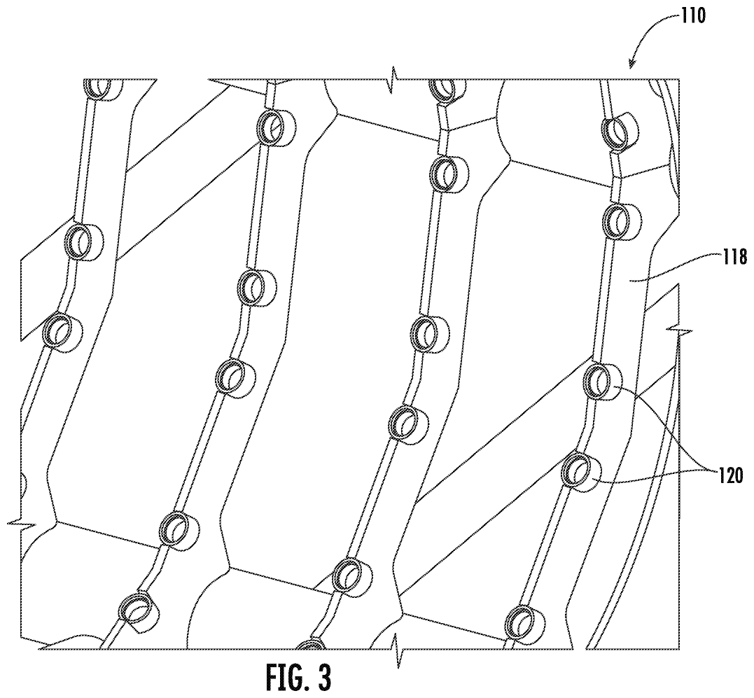

Support frame 110 may be configured to support a plurality of screen panels 114 that generally define a screening surface 116. In this regard, referring now also to FIG. 2, trommel assembly 100 is illustrated with screen panels 114 removed. As shown, trommel frame 110 may include a plurality of circumferential stringers 118 that are mounted to or supported by support structures 112 and extend around the circumferential direction C. As best shown in FIG. 3, a plurality of ferrules 120 may be mounted to circumferential stringers 118 and are spaced apart along the circumferential direction C. Ferrules 120 may be rigid sleeves, e.g., formed from steel or another suitably rigid material, and may be welded, fastened, or otherwise secured to circumferential stringers 118. As described below, ferrules 120 may be used for fastening screen panels 114 to circumferential stringers 118.

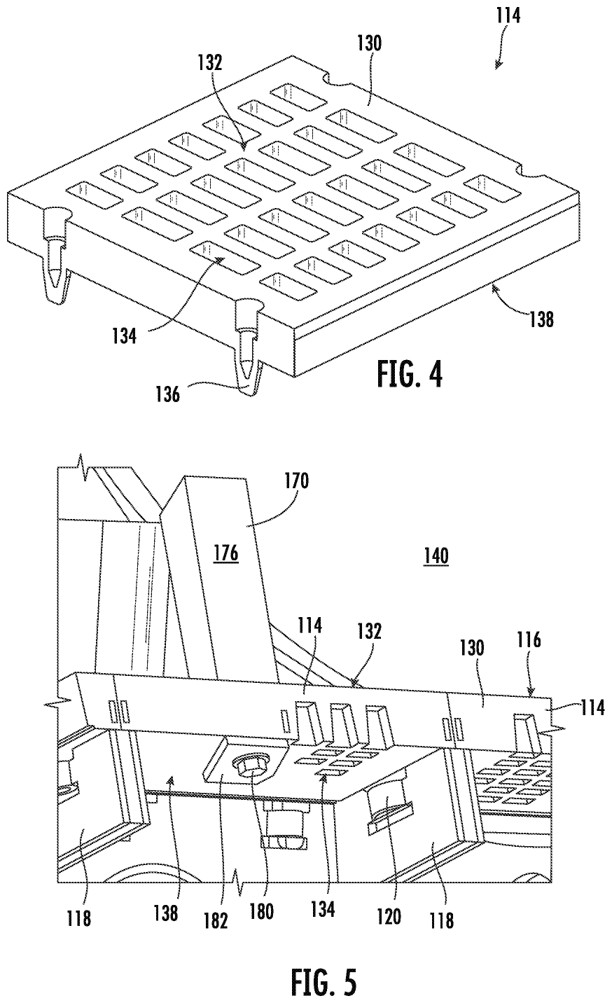

Referring now also to FIGS. 4 and 5, an example screen panel 114 and a cross-sectional view of screen panel 114 installed in trommel assembly 100 is provided. As shown, screen panel 114 may include a perimeter frame 130 surrounding a screening region 132. Specifically, perimeter frame 130 may be a substantially solid frame surrounding and supporting a screening region 132 of screen panel 114, which may define a plurality of apertures 134 inside perimeter frame 130 through which screening material is filtered. Apertures 134 are illustrated as rectangular openings sized for passing a target size of material. However, it should be appreciated that apertures 134 may have any other suitable size, shape, and configuration.

Screen panel 114 may be formed from any suitably rigid material. For example, according to an example aspect of the present disclosure, screen panel 114 may include a polymer matrix or other suitable support frame for maintaining the integrity of apertures 134 through the intense screening process. In some embodiments, a reinforcing structure can be embedded within the polymer matrix or attached to the polymer matrix to provide strength and stiffness to the composite screening panel 114. The polymer can be of any type such as a rubber or urethane elastomer or blends of elastomers or other suitable polymers. For example, the reinforcing structure can be made of steel, aluminum, fiber reinforced polymer, or other suitable reinforcing materials and can be shaped to facilitate the size and shape of apertures 134.

According to example embodiments, each screen panel 114 may have a plurality of mounting pins 136 that extend from a bottom face 138 of perimeter frame 130. Mounting pins 136 may be integrally formed within screen panel 114 or may be attached in any other suitable manner. In general, mounting pins 136 may be configured for receipt within ferrules 120 to fasten screen panels 114 to circumferential stringer 118 and trommel frame 110. More specifically, each ferrule 120 may be configured for receiving two mounting pins 136 from adjacent screen panels 114. The mounting pins 136 may be passed through the ferrule 120 and a securing pin (not shown) may pass through the ferrule to secure mounting pins 136 within ferrule 120 and screen panels 114 within trommel frame 110.

The screen panels 114 mounted to the trommel frame 110 may generally define screening surface 116. As illustrated, the plurality of screen panels 114 may be mounted to trommel frame 110 to define the screening surface 116 that generally defines an outer boundary of a material processing channel 140. In general, material processing channel 140 may be a substantially cylindrical passage through which screening material passes as trommel assembly 100 is rotated. According to the illustrated embodiment, screen panels 114 are flat and are stacked around an entire circumference of trommel frame 110 to define a plurality of facets of a substantially cylindrical material processing channel 140. For example, at any given circumference of trommel assembly 100, material processing channel 140 may be defined by between 10 and 26 panels, by between 14 and 22 panels, or by about 18 panels. According to alternative embodiments, screen panels 114 may be curved to define a completely cylindrical material processing channel 140.

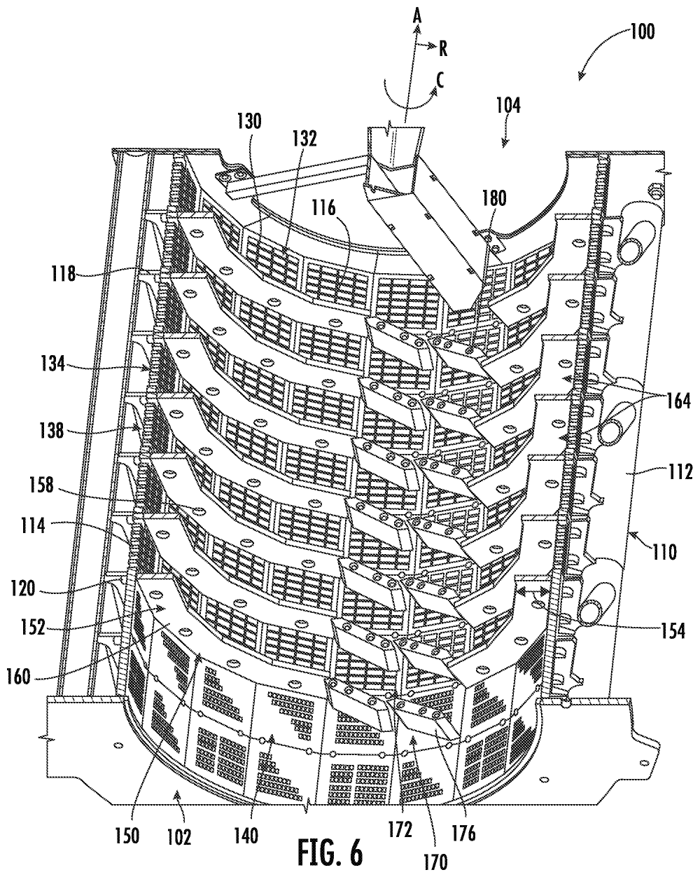

Referring now also to FIGS. 6 through 9, trommel assembly 100 may further include a gate assembly 150 which is generally configured to advance screening material through material processing channel 140 as trommel assembly 100 is rotated. According to an example embodiment, gate assembly 150 may generally be mounted to screen panels 114 and may extend into material processing channel 140 along the radial direction R. Although gate assembly 150 is described herein as being mounted to screen panels 114 and example mounting structures are described herein, it should be appreciated that the various components of gate assembly 150 may be secured within material processing channel 140 in any other suitable manner. Indeed, the gate assembly 150 described herein is only intended to facilitate discussion of aspects of the present subject matter. Variations and modifications may be made to gate assembly 150 while remaining within the scope of the present subject matter.

As illustrated, gate assembly 150 generally includes a plurality of circumferential dams 152 that extend substantially along the circumferential direction C within material processing channel 140. In this regard, circumferential dams 152 may extend from screening surface 116 inward along the radial direction R, e.g., to help direct the flow of screening material as trommel assembly 100 rotates. For example, circumferential dams 152 may define a dam height 154 measured along the radial direction R from screening surface 116 to a distal end of the circumferential dam 152. According to example embodiments, dam height 154 is between about 3 inches and 14 inches, between about 5 inches and 12 inches, or between about 8 inches and 10 inches. Other dam heights 154 are possible depending on the particular application, screening material, trommel size, etc.

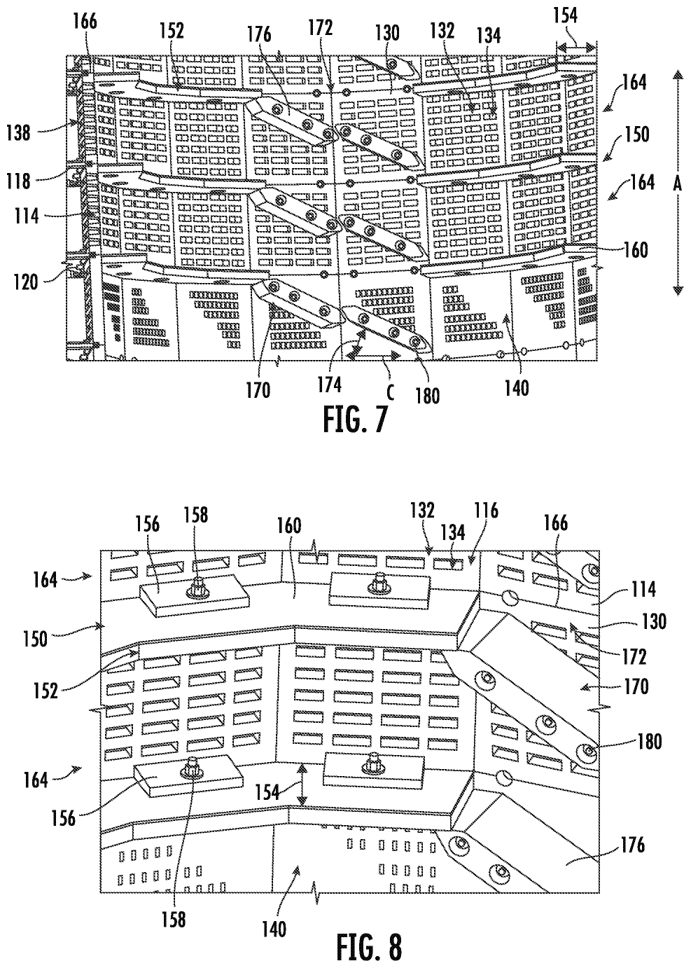

In general, circumferential dams 152 may be mounted within trommel assembly 100 in any suitable manner. For example, as best illustrated in FIG. 8, according to an example embodiment, at least one of screen panels 114 defines a dam mounting plate 156 that extends into material processing channel 140 along the radial direction R to provide a support structure upon which circumferential dams 152 may be mounted using a mechanical fastener 158 (e.g., such as a screw, a nut and bolt, etc.). According to still other embodiments, circumferential dams 152 may be integrally molded or formed into each screen panel 114, e.g., as a radial extension thereof.

In addition, it should be appreciated that each circumferential dams 152 (e.g., the circumferential dams 152 at each axial position) may be formed as a single piece or may include a plurality of dam panels 160 that collectively form the circumferential dam 152 at that given axial position. For example, FIGS. 7 and 8 illustrate that each circumferential dam 152 includes a plurality of dam panels that may be separately installed, e.g., such that a single dam panel 160 extending across four screen panels 114. However, it should be appreciated that any given circumferential dam 152 may include a single panel 160 or any other suitable number of panels 160, e.g., selected based on ease installation, simplicity of attachment, etc.

In addition, as best illustrated in FIGS. 6 through 9, the plurality of circumferential dams 152 are spaced apart along the axial direction A to define a plurality of screening stages 164. In this regard, circumferential dams 152 may be spaced apart between feed end 102 and discharge end 104 to define a plurality of paths through which screening material passes within trommel assembly 100. Notably, the use of circumferential dams 152 facilitates more stages within a given axial length of a trommel assembly. For example, according to the example embodiments, trommel assembly 100 may include between 4 and 12 screening stages, between 5 and 10 screening stages, between 6 and 9 screening stages, or about 7 screening stages. Each screening stage 164 may be substantially constant in height as measured along the axial direction A, e.g., to reduce pinch points and ensure consistent material flow.

As explained above, conventional flow control devices block a large number of screening apertures, resulting in reduced screening efficiency. According to example embodiments of the present subject matter, circumferential dams 152 are positioned over perimeter frame 130 of screen panels 114 when installed. In this regard, for example, adjacent rows of screen panels 114 form a circumferential seam 166 (see, e.g., FIG. 7), and circumferential dams 152 may be positioned over circumferential seam 166 when installed. Notably, this significantly reduces or eliminates the number of apertures 134 that are covered by flow control devices, e.g., by portions of gate assembly 150, for increased screening area. In addition, mounting circumferential dams 152 over circumferential seams 166 may improve the structural rigidity of the system of screen panels 114, e.g., by securing together adjacent screen panels 114.

According to the illustrated embodiment, circumferential dams 152 extend along the circumferential direction C. However, it should be appreciated that circumferential dams 152 may form a slight angle relative to the circumferential direction C without departing from the scope of the present subject matter. In this regard, for example, circumferential dams 152 may extend at a screening stage angle that is defined relative to the circumferential direction C (e.g., measured similar to transfer angle 174, introduced below). According to example embodiments, the screening stage angle may be less than 10 degrees, less than 5 degrees, or smaller. Other angles are possible and within the scope of the present subject matter.

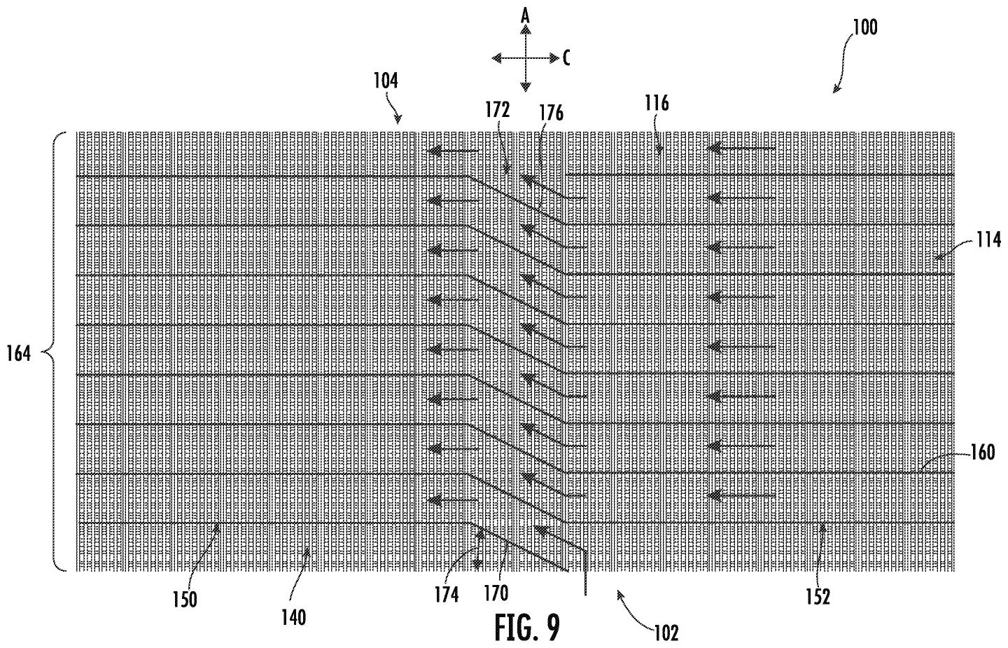

Notably, it may be desirable to advance screening material sequentially through screening stages 164. Accordingly, gate assembly 150 may further include a plurality of transfer gates 170 that are generally configured for advancing screening material through the screening stages (e.g., as best shown in FIG. 9). In other words, transfer gates 170 connect the plurality of screening stages 164 such that rotating trommel assembly 100 advances the screening material through material processing channel 140 from feed end 102 to discharge end 104.

More specifically, circumferential dams 152 may define a circumferential gap 172, which is a void in the otherwise completely circumferential flow control device. Transfer gates 170 may be angled relative to the circumferential direction C for transferring screening material along the axial direction A between adjacent screening stages 164 and through circumferential gap 172. In this regard, circumferential gap 172 may be sized such that the screening material may flow between screening stages 164, but such that the blocked apertures 134 that may result from transfer gates 170 are minimized. For example, according to an example embodiment, circumferential gap 172 may span between 1 and 5 screen panels 114, or may be less than 25%, less than 15%, or less, of a circumference of the material processing channel 140.

According to example embodiments, each of the transfer gates 170 may extend at a transfer angle 174 (FIG. 7) measured relative to the circumferential direction C between adjacent dams of the plurality of circumferential dams 152. In general, the transfer angle 174 may be selected based on the axial height of screening stages 164 and the size of the circumferential gap 172, e.g., such that transfer gates 170 bridge the circumferential gap 172 while advancing material axially between screening stages 164. According to example embodiments, transfer angle 174 is between about 10 and 60 degrees, between about 15 and 45 degrees, or about 27 degrees. Other suitable transfer angles are possible and within the scope of the present subject matter.

Similar to circumferential dams 152, transfer gates 170 may include any suitable number of transfer panels 176 that collectively form the transfer gate 170 spanning between adjacent screening stages 164. For example, FIG. 7 illustrates two transfer panels 176 at each screening stage 164, each of which is mounted on a separate screen panel 114 to bridge the circumferential gap 172 that is two screening panels 114 in length. Other suitable numbers of transfer panels 176 may be used and each panel may have the same transfer angle 174 or different transfer angle 174, depending on the application.

In general, transfer gates 170 may be mounted within trommel assembly 100 in any suitable manner. For example, as best illustrated in FIG. 5, according to an example embodiment, each transfer panel 176 of transfer gates 170 may generally define an aperture that extends along the radial direction R through transfer panel 176. This aperture is generally configured for receiving a mechanical fastener 180 that passes through transfer panel 176 and through screen panel 114 before being secured using a backer plate 182. According to still other embodiments, transfer gates 170 may be integrally molded or formed into each screen panel 114, e.g., as a radial extension thereof.

As explained above, conventional trommel flow control devices are helical scrolls that have a tendency to advance screening material too quickly, resulting in poor material screening. In addition, these helical scrolls have a tendency to block a large number and area of screen apertures, thereby reducing the screening efficiency for a given area. As a result, conventional trommels are inefficient and must typically be larger for effective screening. Accordingly, aspects of the present subject matter are directed to improved gate assemblies or flow control devices for an improved screening process and screening efficiency.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A trommel assembly defining an axial direction, a radial direction, and a circumferential direction, the trommel assembly comprising:
a trommel frame;
a plurality of screen panels mounted to the trommel frame to define a material processing channel inside the plurality of screen panels along the radial direction, the material processing channel being configured for receipt of screening material; and
a gate assembly mounted to the plurality of screen panels, the gate assembly extending into the material processing channel along the radial direction and comprising:
a plurality of circumferential dams that extend substantially along the circumferential direction, the plurality of circumferential dams being spaced apart along the axial direction to define a plurality of screening stages; and
a plurality of transfer gates, each of the plurality of transfer gates extending at a transfer angle relative to the circumferential direction between adjacent dams of the plurality of circumferential dams, wherein the plurality of transfer gates connect the plurality of screening stages such that rotating the trommel assembly advances the screening material through the material processing channel.

2. The trommel assembly of claim 1, wherein each of the plurality of screen panels comprises a perimeter frame and a plurality of apertures defined inside the perimeter frame, and wherein each of the plurality of circumferential dams are positioned over the perimeter frame when installed.

3. The trommel assembly of claim 1, wherein adjacent rows of the plurality of screen panels form a circumferential seam, and wherein the plurality of circumferential dams is positioned over the circumferential seam when installed.

4. The trommel assembly of claim 1, wherein the plurality of circumferential dams define a screening stage angle that is defined relative to the circumferential direction, wherein the screening stage angle is less than 10 degrees.

5. The trommel assembly of claim 4, wherein the screening stage angle is less than 5 degrees.

6. The trommel assembly of claim 1, wherein the transfer angle of the plurality of transfer gates is between 15 and 45 degrees.

7. The trommel assembly of claim 6, wherein the transfer angle is about 27 degrees.

8. The trommel assembly of claim 1, wherein each of the plurality of circumferential dams defines a circumferential gap, and wherein the circumferential gap is less than 25% of a circumference of the material processing channel.

9. The trommel assembly of claim 8, wherein the circumferential gap is less than 15% of the circumference of the material processing channel.

10. The trommel assembly of claim 8, wherein one of the plurality of transfer gates bridges the circumferential gap between adjacent dams of the plurality of circumferential dams to join adjacent stages of the plurality of screening stages.

11. The trommel assembly of claim 1, wherein at least one of the plurality of screen panels defines a dam mounting plate that extends into the material processing channel along the radial direction.

12. The trommel assembly of claim 1, wherein each of the plurality of circumferential dams comprises a plurality of dam panels.

13. The trommel assembly of claim 1, wherein each of the plurality of transfers gates comprises a plurality of transfer panels.

14. The trommel assembly of claim 1, wherein the plurality of circumferential dams defines a dam height measured along the radial direction, wherein the dam height is between 3 inches and 14 inches.

15. The trommel assembly of claim 14, wherein the dam height is between 8 inches and 10 inches.

16. The trommel assembly of claim 1, wherein the plurality of screening stages comprises between 5 and 10 screening stages.

17. The trommel assembly of claim 1, wherein the trommel frame comprises:
a plurality of circumferential stringers; and
a plurality of ferrules mounted to the circumferential stringers, the plurality of ferrules being configured for receiving a mounting pin of one or more of the plurality of screen panels.

18. A gate assembly mounted within a trommel, the trommel defining an axial direction, a radial direction, and a circumferential direction, the trommel comprising a trommel frame supporting a plurality of screen panels to define a material processing channel, the gate assembly comprising:
a plurality of circumferential dams mounted to the plurality of screen panels and extending substantially along the circumferential direction, the plurality of circumferential dams being spaced apart along the axial direction to define a plurality of screening stages; and
a plurality of transfer gates, each of the plurality of transfer gates extending at a transfer angle relative to the circumferential direction between adjacent dams of the plurality of circumferential dams, wherein the plurality of transfer gates connect the plurality of screening stages.

19. The gate assembly of claim 18, wherein each of the plurality of screen panels comprises a perimeter frame and a plurality of apertures defined inside the perimeter frame, and wherein each of the plurality of circumferential dams are positioned over the perimeter frame when installed.

20. The gate assembly of claim 18, wherein adjacent rows of the plurality of screen panels form a circumferential seam, and wherein the plurality of circumferential dams is positioned over the circumferential seam when installed.
